(19) United States
(12) Patent Application Publication
(10) Pub. No.: US 2011/0051442 A1
(43) Pub. Date: Mar. 3, 2011

(54) BIKE HANDLEBAR GRIP STRUCTURE HANGING CAUTION/DIRECTION LIGHT DEVICE

(76) Inventor: Chin-Yu CHANG, Taipei City (TW)

(21) Appl. No.: 12/624,146

(22) Filed: Nov. 23, 2009

(30) Foreign Application Priority Data
Sep. 3, 2009 (TW) 098129633

(51) Int. Cl. B62J 6/00; B62K 21/26; B62J 29/00

(52) U.S. Cl. 362/474; 74/551.9; 359/842; 362/184

(57) ABSTRACT

The present invention discloses a bike handlebar grip structure, which comprises an elastic grip body and a caution/direction light device. The elastic grip body can elastically and detachably sleeve the handlebar and has a switch device. The caution/direction light device is hanged to the outer end of the elastic grip body and electrically connected to the switch device of the elastic grip body. The width and length of the caution/direction light device are greater than the diameter of the elastic grip body. The present invention can be conveniently assembled to or disassembled from a bike. Further, the caution/direction light device of the present invention is hanged to the outer end of the handlebar. Thus, the preset invention can promote the warning effect and biking safety.

### BACKGROUND OF THE INVENTION

1. Field of the Invention

The present invention relates to a bike caution/direction light device, particularly to a detachable bike handlebar grip structure hanging a caution/direction light device.

2. Description of the Related Art

With emergence of the environmental protectionism, energy saving and carbon emission reduction has been gradually put into practice in daily living. Further, people make much of their health and leisure activities now. Biking not only excises our bodies but also reduces waste gas emitted by general traffic tools. Thus, biking becomes very popular, and many people use bikes as traffic tools or leisure-activity equipment.

Not all regions have ready bikeways. Therefore, bikers usually have to bike on sidewalks or traffic lanes together with pedestrians, motorcycles and automobiles. Such a case is likely to incur traffic accidents and endanger bikers. Bikes usually have none of headlights, taillights and direction lights. Such a case further endangers bikers at night or in a dim light environment. Therefore, many bikers install headlights and taillights on their bikes to remind others and improve biking safety. However, rare bikers install direction lights on their bikes. Therefore, they cannot warn the drivers in rear vehicles when they intend to turn. Such a case may endanger bikers also.

To solve the abovementioned problem, manufacturers had proposed several types of handlebar grips with caution lights. The related patents thereof include Taiwan patents of No. M298566, No. M340972, No. M360830, etc. Each of Taiwan patents of No. M298566 and No. M340972 has a transparent handlebar grip. A light-emitting element or a reflective layer is arranged inside the handlebar grip. The light-emitting element or the reflective layer enables the handlebar grip to emit light. However, the light-emitting element is positioned at the inner end of the handlebar in Taiwan patent No. M298566. For drivers of rear vehicles, the light is thus completely shaded by the biker. In Taiwan patent No. M340972, the light-emitting device is arranged in the outer end of the handlebar. However, the size of the light-emitting device is smaller than the diameter of the handlebar. Thus, the light is likely to be shaded by the arms of the bikers. In Taiwan patent No. M340972, there are numerous complicated components, which make the assemblage and usage thereof very troublesome. Further, the size of the light seat is also smaller than the diameter of the handlebar. Therefore, the light is also likely to be shaded by the arms of the biker.

The abovementioned patent products have to be installed on handlebars fixedly. When the bike is not in use, the products are unlikely to detach from the handlebars. Thus, rain and sunshine will decrease the lifetime of the products. Further, the products are easy to damage or steal.

### SUMMARY OF THE INVENTION

The primary objective of the present invention is to provide a bike handlebar grip structure, wherein a caution/direction light device hangs in the outer end of the handlebar grip, and wherein the width and length of the caution/direction light are greater than the diameter of the handlebar grip, whereby is effectively enhanced the warning effect of the caution/direction lights.

Another objective of the present invention is to provide a bike handlebar grip structure, which is detachably installed on the handlebar, whereby the present invention can be fast assembled to a bike when in use and disassembled from the bike when not in use.

A further objective of the present invention is to provide a bike handlebar grip structure, which can be elastically assembled to the handlebars of different bikes.

To achieve the abovementioned objectives, the present invention proposes a bike handlebar grip structure, which applies to a bike handlebar, and which comprises an elastic grip body and a caution/direction light device. The elastic grip body has an accommodation space corresponding to the bike handlebar and can elastically and detachably sleeve the handlebar. The surface of the elastic grip body has a switch device. The caution/direction light device is hanged to the outer end of the elastic grip body and electrically connected to the switch device of the elastic grip body. The caution/direction light device has a seat attached to the elastic grip body, a cover covering the seat, and a light-emitting module arranged in the seat. The width and length of the caution/direction light device are greater than the diameter of the elastic grip body.

In a preferred embodiment, the elastic grip body has a plurality of perforated holes; the elastic grip body also has a plurality of drainage holes and a plurality of wire holes on the bottom thereof. The outer end of the elastic grip body has a first hanging member. The inner end of the caution/direction light device has a second hanging member corresponding to the first hanging member.

In comparison with the conventional technologies, the bike handlebar grip structure of the present invention has an elastic grip body, which can flexibly sleeve the handlebar of any bike. Therefore, the present invention can be fast assembled to any handlebar. The caution/direction light device of the present invention can be easily hanged to the outer end of the elastic grip body. Therefore, the assemblage of the caution/direction light device is very convenient. In addition to being attached to the outer end of the elastic grip body, the caution/direction light device has width and length greater than the diameter of the handlebar. Therefore, the light of the caution/direction light device is exempted from being shaded by the arms of the biker in the present invention. Accordingly, the present invention can obviously enhance the warning effect and biking safety.

### BRIEF DESCRIPTION OF THE DRAWINGS

FIG. 1 is a perspective exploded-view drawing of a bike handlebar grip structure according to a first preferred embodiment of the present invention;

FIG. 2 is a perspective assembly drawing of a bike handlebar grip structure according to the first preferred embodiment of the present invention;

FIG. 3 is a side-view exploded sectional drawing of a bike handlebar grip structure according to the first preferred embodiment of the present invention;

FIG. 4 is a side-view sectional assembly drawing of a bike handlebar grip structure according to the first preferred embodiment of the present invention;

FIG. 5 is a side-view appearance drawing of a bike handlebar grip structure according to the preferred embodiment of the present invention;

FIG. 6 is a top-view sectional assembly drawing of a bike handlebar grip structure according to the preferred embodiment of the present invention;

FIG. 7 is a drawing schematically showing an application of a bike handlebar grip structure according to the first preferred embodiment of the present invention;

FIG. 8 is a perspective appearance drawing of a bike handlebar grip structure according to a second preferred embodiment of the present invention;

FIG. 9 is a perspective assembly drawing of a bike handlebar grip structure according to a third preferred embodiment of the present invention;

FIG. 10 is a perspective exploded-view drawing of a bike handlebar grip structure according to the third preferred embodiment of the present invention;

FIG. 11 is a side-view exploded sectional drawing of a bike handlebar grip structure according to the third preferred embodiment of the present invention;

FIG. 12 is a side-view sectional assembly drawing of a bike handlebar grip structure according to the third preferred embodiment of the present invention; and

FIG. 13 is a drawing schematically showing an application of a bike handlebar grip structure according to the third preferred embodiment of the present invention.

### DETAILED DESCRIPTION OF THE INVENTION

Below, special embodiments are described in detail to demonstrate the present invention, whereby the persons skilled in the art can easily understand the technical contents, characteristics and efficacies of the present invention.

The embodiments will be described in cooperation with the attached drawings. It should be noted that the drawings are only to schematically show the fundamental concepts of the present invention but not to include all the details of the practical applications. The schematic drawings are not depicted according to the real numbers, shapes and dimensions of the components of the practical applications of the present invention. Therefore, the present invention is not limited to the disclosed embodiments or drawings but includes various modifications and variations.

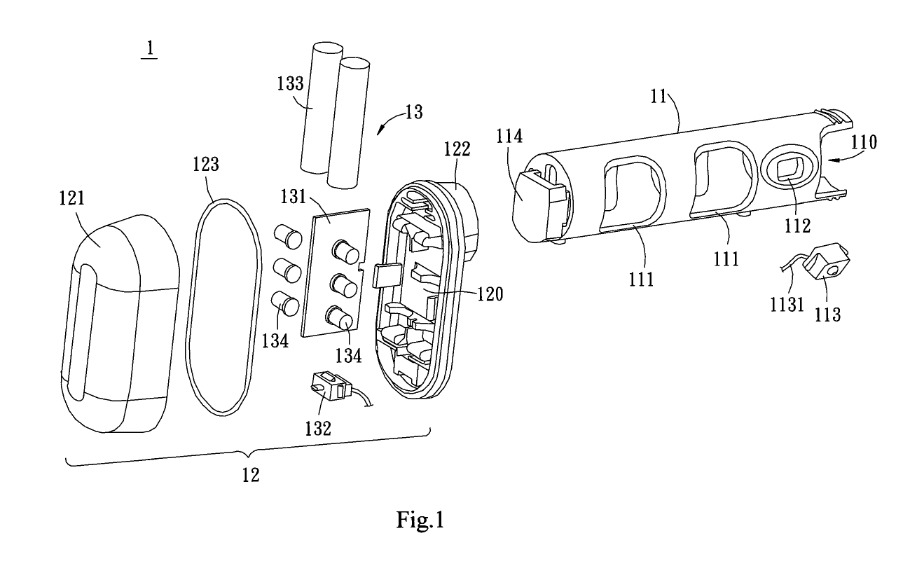

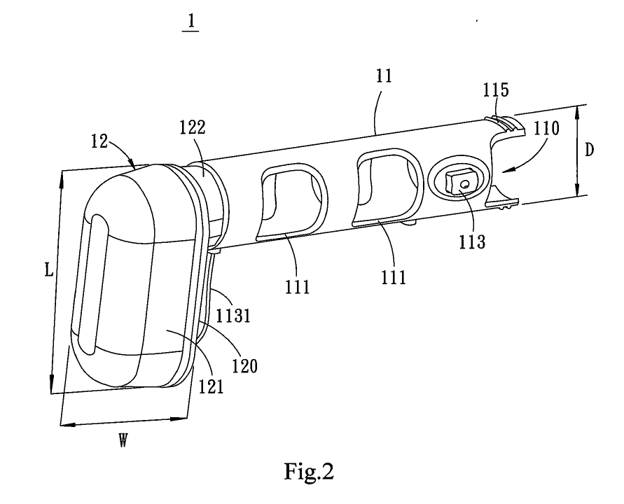

Refer to FIG. 1 and FIG. 2 respectively a perspective exploded-view drawing, and a perspective assembly drawing of a bike handlebar grip structure according to a first preferred embodiment of the present invention. The bike handlebar grip structure 1 of the present invention applies to a bike handlebar and comprises an elastic grip body 11 and a caution/direction light device 12 hanging to the outer end of the elastic grip body 11.

The elastic grip body 11 has an accommodation space 110 corresponding to the bike handlebar. The elastic grip body 11 has a plurality of perforated holes 111 and at least one switch fixing hole 112. The perforated holes 111 can increase the elasticity of the elastic grip body 11. The switch fixing hole 112 is used to install a switch device 113. The outer end of the elastic grip body 11 has a first hanging member 114. The elastic grip body 11 has a plurality of slip-proof convex rings 115 near the inner end thereof.

The caution/direction light device 12 has a seat 120 and a cover 121 covering the seat 120. The seat 120 has a light-emitting module 13. The light-emitting module 13 includes a circuit board 131. The light-emitting module 13 also includes a power source seat 132, two batteries 133 and a plurality of light-emitting elements 134, which are all arranged on the circuit board 131. The inner end of the caution/direction light device 12 has a second hanging member 122 corresponding to the first hanging member 114. The width W and length L of the caution/direction light device 12 are greater than the diameter D of the elastic grip body 11. A water-proof washer 123 is arranged between the seat 120 and the cover 121 to prevent water from entering the interior of the seat 120 or the cover 121.

In first embodiment, the elastic grip body 11 is made of an elastic rubber or an elastic plastic. The elastic grip body 11 can elastically sleeve the handlebars (not shown in the drawings) of various bikes. The caution/direction light device 12 has a rectangular seat 120 and a cover 121 having a shape corresponding to the shape of the seat 120. The width W and length L of the caution/direction light device 12 are greater than the diameter D of the elastic grip body 11. The circuit board 131 of the light-emitting module 13 is arranged in the center of the seat 120. The two batteries 133 are respectively arranged on two sides of the circuit board 131. The plurality of light-emitting elements 134 is also arranged on two sides of the circuit board 131. The number of the light-emitting elements 134 is not limited by the first embodiment. In other embodiments, the light-emitting elements 134 may have different numbers.

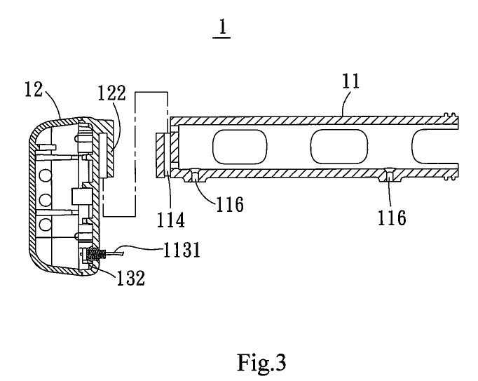

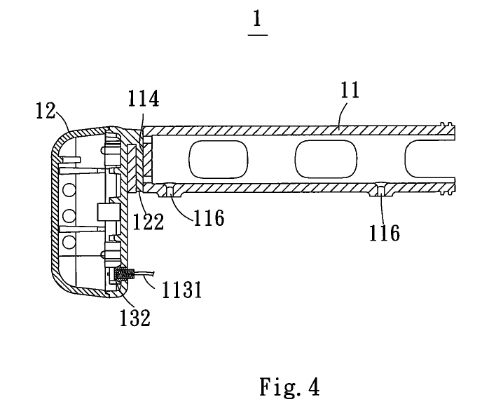

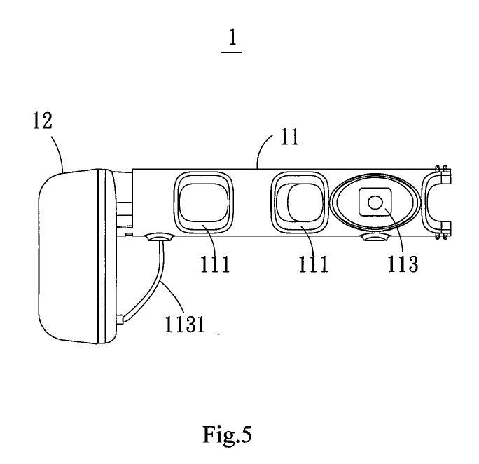

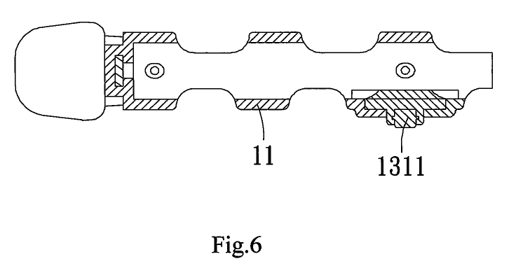

Refer to FIGS. 3-6 respectively a side-view exploded sectional drawing, a side-view sectional assembly drawing, a side-view appearance drawing, and a top-view sectional assembly drawing of a bike handlebar grip structure of the first preferred embodiment of the present invention. The elastic grip body 11 of the bike handlebar grip structure 1 of the present invention has a first hanging member 114 on the outer end thereof. The caution/direction light device 12 has a second hanging member 122 on the inner end thereof and corresponding to the first hanging member 114. As shown in FIG. 3 and FIG. 4, the first hanging member 114 is a hanging slot, and the second hanging member 122 is a hanging plate, whereby the second hanging member 122 can be fast hanged to the outer end of the first hanging member 114. Thus, the caution/direction light device 12 can be fast attached to the outer end of the elastic grip body 11. The bottom of the elastic grip body 11 has wire holes 116 and drainage holes. The switch device 113 is electrically connected to the power source seat 132 via a wire 1131. As shown in FIG. 6, the switch device 113 is firmly fixed to the elastic grip body 11 in an elastic press-fit way. The wire 1131 extends from the switch device 113 through the wire hole 116 to the power seat 132, whereby the switch device 113 can control the caution/direction light device 12 to emit light.

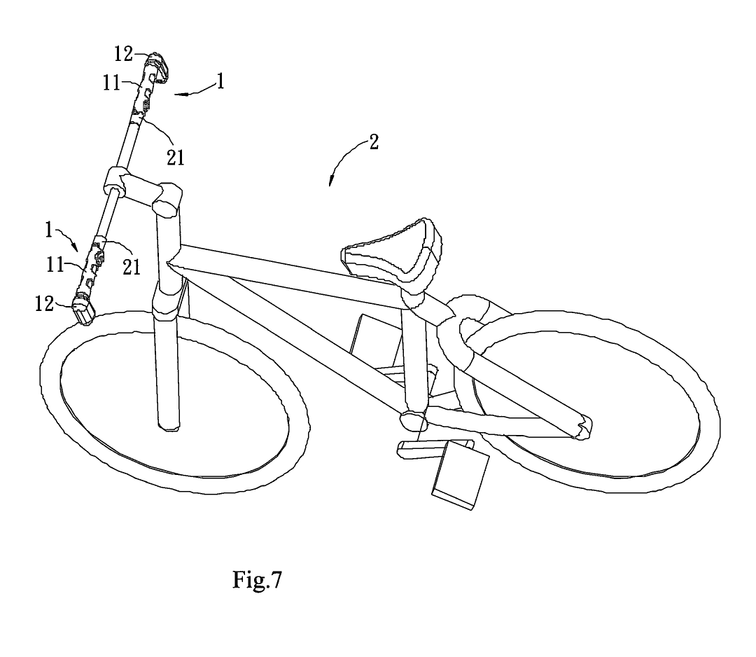

Refer to FIG. 7 for an application of a bike handlebar grip structure according to the first embodiment of the present invention. In the preferred application of the bike handlebar grip structure 1 of the present invention, the left and right handlebars 21 of a bike 2 are respectively sleeved by two elastic grip bodies 11. Then, two caution/direction light devices 2 are respectively hanged to the outer ends of the elastic grip bodies 11. Thereby, the present invention is fast assembled to the bike 2. Refer to FIG. 2 again. The width W and length L of the caution/direction light device 12 are greater than the diameter D of the elastic grip body 11. Thus, the width W and length L of the caution/direction light device 12 are also greater than the diameter D of the handlebars 21. Then, the caution/direction light device 12 is obviously greater than the handlebars 21. Therefore, in practical application, the arms of the biker will not shade the light of the caution/direction light devices 2 at all, and the drivers of the front and rear vehicles can see the light of the caution/direction light devices 2 clearly. Thus is promoted the warning effect and biking safety.

When not in use, the bike handlebar grip structures 1 of the present invention can be directly detached from the handlebars 21. The detachable design can prevent the bike handlebar grip structures 1 from rain and sunshine and prolong the lifetime thereof. Further, the detachable design can prevent the bike handlebar grip structures 1 from damage or stealth.

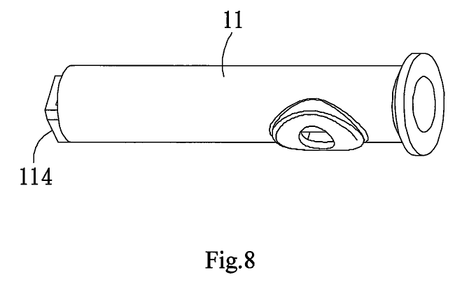

Refer to FIG. 8 a perspective appearance drawing of a bike handlebar grip structure according to a second preferred embodiment of the present invention. In the second preferred embodiment, the elastic grip body 11 is free of perforated holes. The elastic grip body 11 of the second preferred embodiment can also sleeve the handlebar (not shown in the drawing) easily. The elastic grip body 11 of the second preferred embodiment also has a first hanging member 114 on the outer end thereof for hanging the caution/direction light device (not shown in the drawing). Therefore, the bike handlebar grip structure of the second preferred embodiment can also be assembled to a bike fast.

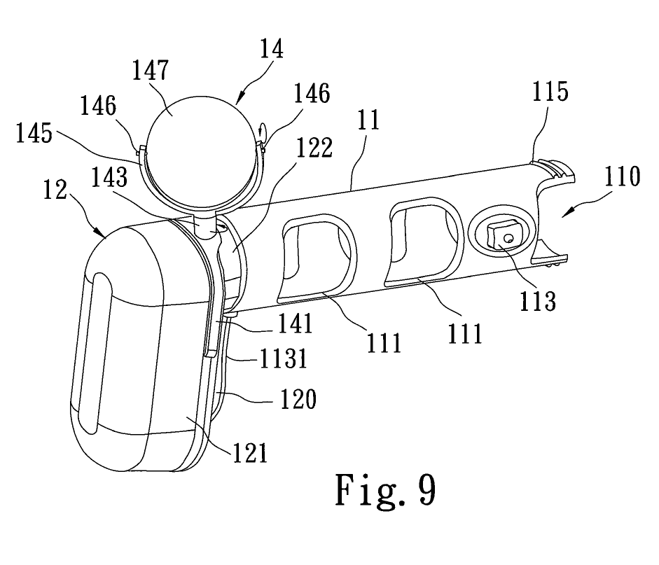

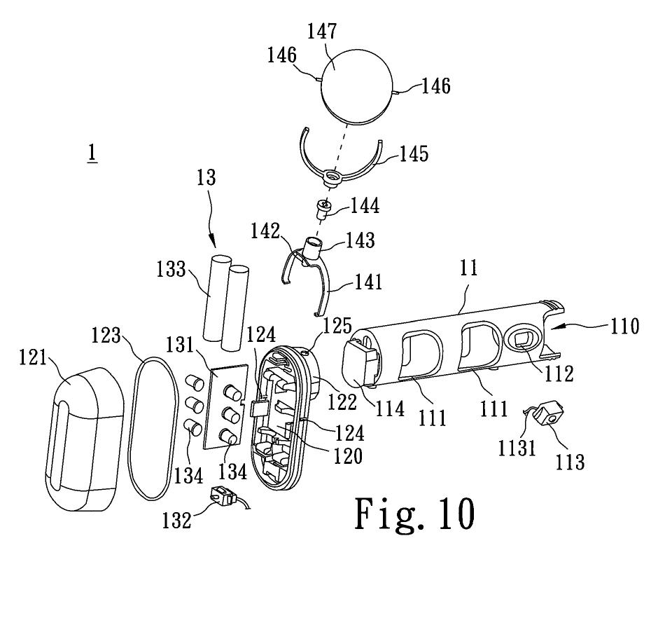

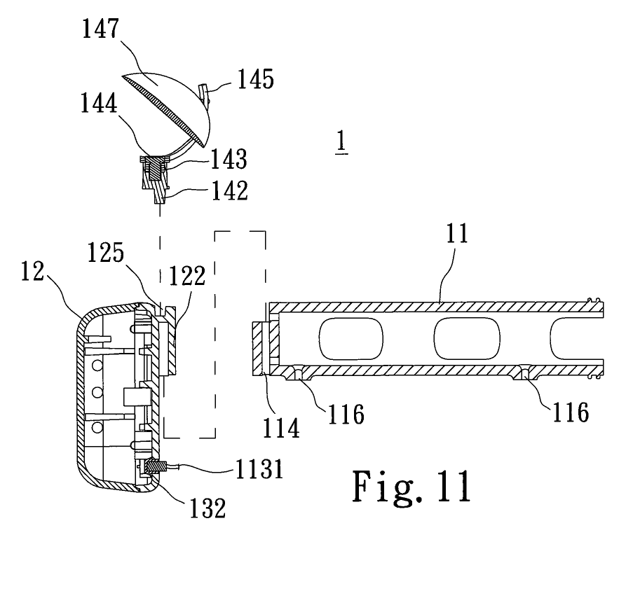

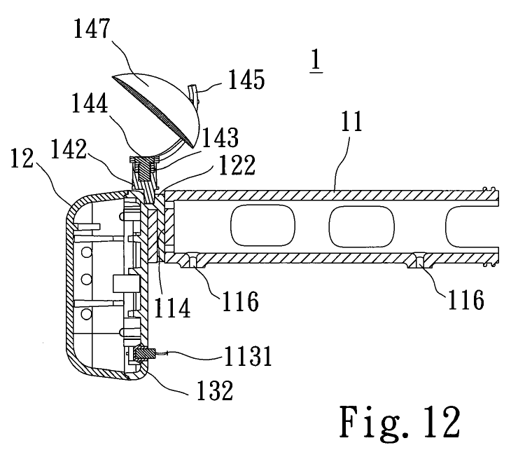

Refer to FIG. 9 a perspective assembly drawing of a bike handlebar grip structure according to a third preferred embodiment of the present invention. The embodiment of FIG. 9 is different from that of FIG. 2 in that the caution/direction light device 12 has an additional back view mirror device 14 in FIG. 9. Refer to FIGS. 10-12. Two opposite sides of the seat 120 of the caution/direction light device 12 respectively have holes 124. The top of the second hanging member 122 has an insertion hole 125. The back view mirror device 14 has a support frame 141 with an insertion member 142. The insertion member 142 is inserted into the insertion hole 125, and the lower tips of the support frame 141 are press-fitted into the holes 124, whereby the support frame 141 is secured to the second hanging member 122. The support frame 141 has a pivotal seat 143, and a pivotal shaft 144 is arranged inside the pivotal seat 143. The pivotal shaft 144 is joined to a frame 145, and the frame 145 rotates horizontally via the pivotal shaft 144 and the pivotal seat 145. The frame 145 has two connection members 146, and a back view mirror 147 is installed on the connection members 146. The back view mirror 147 rotates back and forth with the connecting line of the two connection members 146 being the axis.

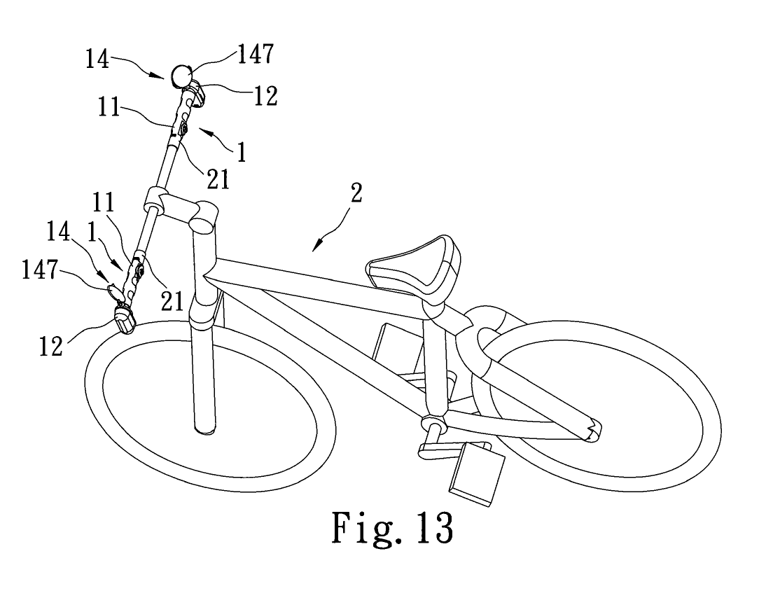

Refer to FIG. 13. The back view mirror devices 14, together with the elastic grip bodies 11 and the caution/direction light devices 12, are respectively installed to the left and right handlebars 21 of a bike 2. The biker can easily rotate the back view mirror 147 horizontally or back-and-forth to attain the best viewing angle for observing the rear vehicles. Thus is promoted biking safety.

In comparison with the conventional technologies, the elastic grip bodies of the present invention can be detachably installed to the handlebars of a bike, and the caution/direction light devices can be detachably hanged to the outer ends of the elastic grip bodies. When in use, the present invention can be easily and fast assembled to a bike. When not in use, the present invention can be easily and fast disassembled from the bike. In the present invention, the width and length of the caution/direction light device are larger than the diameter of the handlebar grip of the bike. Therefore, the arms of the biker will not shade the light of the caution/direction light devices, and the drivers of the rear vehicles can see the light clearly. Thus is promoted the warning effect and biking safety. Therefore, the present invention can achieve the intended efficacies.

The embodiments have been described in detail thereinbefore. However, the embodiments are only to exemplify the present invention but not to limit the scope of the present invention. Any revision in forms, structures, layouts, proportions, materials, components or modules according to the spirit or principles of the present invention shall not depart from the scope of the present invention. Therefore, any equivalent modification or variation is to be also included within the scope of the present invention.

What is claimed is:

1. A bike handlebar grip structure, which applies to a handlebar of a bike, comprising
an elastic grip body having an accommodation space corresponding to said handlebar, detachably and elastically sleeving said handlebar, and having a switch device on a surface thereof; and
a caution/direction light device hanging to an outer end of said elastic grip body, electrically connected to said switch device of said elastic grip body, and including a seat and a cover, wherein said seat connects to said elastic grip body and has a light-emitting module, and wherein said cover covers said seat.

2. The bike handlebar grip structure according to claim 1, wherein said elastic grip body has a plurality of perforated holes.

3. The bike handlebar grip structure according to claim 1, wherein said elastic grip body has a switch fixing hole for installing said switch device.

4. The bike handlebar grip structure according to claim 1, wherein said elastic grip body has a first hanging member on an outer end thereof.

5. The bike handlebar grip structure according to claim 4, wherein said first hanging member is a hanging slot.

6. The bike handlebar grip structure according to claim 4, wherein said seat of said caution/direction light device has a second hanging member on an inner end thereof and corresponding to said first hanging member.

7. The bike handlebar grip structure according to claim 6, wherein said second hanging member is a hanging plate.

8. The bike handlebar grip structure according to claim 1, wherein said light-emitting module includes a circuit board, a power source seat, at least one battery and a plurality of light-emitting elements; said circuit board, said power source seat, said at least one battery and said light-emitting elements are arranged on said circuit board; an illumination direction of said light-emitting module is parallel to an advancing direction of said bike.

9. The bike handlebar grip structure according to claim 1, wherein said switch device is electrically connected to said power source seat via a wire.

10. The bike handlebar grip structure according to claim 1, wherein said elastic grip body has a plurality of slip-proof convex rings on a surface near an inner end of said elastic grip body.

11. The bike handlebar grip structure according to claim 1, wherein said elastic grip body has a plurality of drainage holes and wire holes on a bottom thereof.

12. The bike handlebar grip structure according to claim 1, wherein a water-proof washer is arranged between said seat and said cover.

13. The bike handlebar grip structure according to claim 1, wherein said caution/direction light device has a width and a length each greater than a diameter of said elastic grip body.

14. The bike handlebar grip structure according to claim 6 further comprising a back view mirror device, wherein two opposite sides of said seat respectively have holes; said a top of said second hanging member has an insertion hole; said back view mirror device is installed in said caution/direction light device via said holes and said insertion hole.

15. The bike handlebar grip structure according to claim 14, wherein said back view mirror device includes
a support frame having an insertion member, wherein said insertion member is inserted into said insertion hole, and wherein lower tips of said support frame are respectively press-fitted into said holes, whereby said support frame is secured to said second hanging member;
a pivotal seat arranged on said support frame and having a pivotal shaft;
a frame having two connection member, joined to said pivotal shaft, and rotating via said pivotal haft and said pivotal seat; and
a back view mirror installed on said connection members and rotating back and forth with a connecting line of said connection members being an axis.
